(19) United States
(12) Patent Application Publication
(10) Pub. No.: US 2015/0043310 A1
(43) Pub. Date: Feb. 12, 2015

(54) SENSOR STATION, SYSTEM AND METHOD FOR SENSING SEISMIC PARAMETERS

(71) Applicant: SHELL OIL COMPANY, Houston, TX (US)

(72) Inventors: Steven James Maas, Pflugerville, TX (US); Akbar Arab-Sadeghabadi, Santa Rosa Valley, CA (US); Daniel Joseph Gentner, JR., Austin, TX (US)

(21) Appl. No.: 14/383,237

(22) PCT Filed: Mar. 5, 2013
(86) PCT No.: PCT/US13/29009

§ 371 Date: Sep. 5, 2014

Related U.S. Application Data
(60) Provisional application No. 61/608,373, filed on Mar. 8, 2012.

(51) Int. Cl. G01V 1/20; G01V 13/00

(52) U.S. Cl. CPC G01V 1/201; G01V 13/00
USPC 367/188; 29/601

(57) ABSTRACT

Sensor stations, system and methods for sensing seismic parameters of a subsurface structure are provided. The sensor station includes a sensor housing and a sensor unit. The sensor housing includes a base with a removable lid and receptacles for receiving the fiber optic cable therethrough. The base has a cavity therein accessible upon removal of the removable lid. The sensor unit is positionable in the cavity of the sensor housing. The sensor unit is operatively connectable to a portion of the optical fibers of the fiber optic cable for communicating seismic data sensed by the sensor unit.

This application claims the benefit of priority of U.S. Provisional Patent Application No. 61/608,373, filed on Mar. 8, 2012, the disclosure of which is incorporated by reference herein in its entirety.

### BACKGROUND

The present disclosure relates generally to techniques for investigating subsurface structures. More specifically, the present disclosure relates to sensors or sensor stations for sensing seismic parameters of a subsurface structure.

The exploration of oil and gas may involve the investigation of subsurface structures, such as geological formations and/or reservoirs. Seismic sensing systems or sensors may be positioned about a surface location for sensing properties of the subsurface structures. Such properties may include physical properties, such as pressure, motion, energy, etc. Such properties may occur naturally, or may be generated by imparting a force to the surface using a seismic energy source (e.g., a seismic vibration truck). The reflected seismic waves generated by the seismic energy source may be collected and analyzed to determine characteristics of the subsurface structures.

Techniques have been developed for sensing seismic parameters. Examples of such techniques are provided in US Patent/Application Nos. 20080062815, 20080060310, and 20080060311. Some seismic sensing systems may be, for example, optical systems including seismic trucks distributed about a location for independently collecting seismic data. The seismic truck may have fiber optic cables with optical sensors distributed about a surface location of a subsurface structure. The cable used in seismic operations may be distributed about a given location from a reel. Sensors may be positioned along the cable and distributed therewith.

The seismic sensing system may also have a light source for emitting a laser through the fiber optic cables. The light source distributes light to and collects light from the optical sensors positioned along the fiber optic cables. The seismic truck may have devices for detecting changes in the light. Such changes may be used to determine information about and generate images of the subsurface structures. Examples of optical systems and sensors for use in seismic operations are described in U.S. Pat. Nos. 6,970,396, 7,222,534, 7,154,082, 6,549,488, 4,648,083, and 4,525,818. Some seismic sensing systems may use electrical geophones, micro-electromechanical system (MEMS), fiber Bragg grating based, or other sensors. Some seismic systems may use intruder detection/perimeter sensing systems.

During use, the sensors and/or cable may be damaged and/or fail. In some cases, such failures may disable the entire fiber optic system. Thus, despite the development of advanced techniques in seismic sensing, there remains a need to provide advanced seismic sensors for use with optical fiber based seismic sensing.

### SUMMARY

The disclosure relates to a sensor station for sensing seismic parameters of a subsurface structure. The sensor station is operatively connectable to a fiber optic cable disposable about a seismic field about the subsurface structure. The fiber optic cable includes a plurality of optical fibers. The sensor station includes a sensor housing and a sensor unit. The sensor housing includes a base with a removable lid and receptacles for receiving the fiber optic cable therethrough. The base has a cavity therein accessible upon removal of the removable lid. The sensor unit is positionable in the cavity of the sensor housing. The sensor unit is operatively connectable to a portion of the optical fibers of the fiber optic cable for communicating seismic data sensed by the sensor unit.

The sensor housing includes a racetrack. The fiber optic cable has a plurality of optical fibers distributable about the racetrack. The sensor station may also include telemetry splitters positionable in the sensor housing and operatively connectable to a portion of the plurality of optical fibers. The telemetry splitters may link fibers of the fiber optic cable about the sensor housing. The sensor station may also include cable clamps at each end of the sensor housing. The cable clamps may support the fiber optic cable to the sensing unit.

The cable clamps may each include a top and a bottom, the top having locking arms insertable into the bottom for interlocking connection therebetween and about the fiber optic cable.

The sensor station may also include cable supports, a spike operatively connectable to the sensor housing, an RFID tag positionable in the sensor housing, and/or a foam protectant positionable in the sensor housing about the optical fibers. The sensor unit may include electronics for collecting seismic parameters. The lid and base may have pockets for receiving the sensor unit.

In another aspect, the disclosure relates to a system for sensing seismic parameters of a subsurface structure. The system includes a fiber optic cable and a sensor station. The fiber optic cable is disposable along a seismic field about the subsurface structure, and includes a plurality of optical fibers. The sensor station includes a sensor housing and a sensor unit. The sensor housing includes a base with a removable lid and receptacles for receiving the fiber optic cable therethrough. The base has a cavity therein accessible upon removal of the removable lid. The sensor unit is positionable in the cavity of the sensor housing. The sensor unit is operatively connectable to a portion of the optical fibers of the fiber optic cable for communicating seismic data sensed by the sensor unit.

The system may also include a base station. The base station may include a light source and a data recording device operatively connectable to the fiber optic cable. The fiber optic cable may include a jacket.

In yet another aspect, the disclosure relates to a method for manufacturing a sensor system for sensing seismic parameters of a subsurface structure. The method involves providing a fiber optic cable and sensor stations, routing the plurality of optical fibers through the sensor housing, and splicing the portion of the plurality of fibers to the sensor unit. The method may also involve clamping the fiber optic cable to each end of the sensor housing and/or providing a radio frequency identification tag in the sensor housing. The splicing may involve operatively connecting telemetry splitters between the plurality of optical fibers and the sensing unit.

Finally, in another aspect, the disclosure relates to a method for sensing seismic parameters of a subsurface structure. The method involves providing fiber optic cable and sensor stations, passing light through the fiber optic cable, collecting data from the subsurface structure with the sensor unit, and communicating the collected data through the fiber optic cable. The method may also involve removing the removable lid and accessing the cavity of the sensor housing, providing a radio frequency identification tag and collecting data from the radio frequency identification tag, routing the plurality of optical fibers through the sensor housing, and/or splicing the portion of the plurality of fibers to the sensor unit.

### BRIEF DESCRIPTION OF THE DRAWINGS

A more particular description of the subject matter, briefly summarized herein, may be had by reference to the embodiments thereof that are illustrated in the appended drawings.

The figures are not necessarily to scale, and certain features and certain views of the figures may be shown exaggerated in scale or in schematic in the interest of clarity and conciseness.

FIGS. 1.1-1.2 depict schematic views of a system for sensing seismic parameters, the system including a seismic cable and a sensor station.

FIG. 2 depicts a schematic view of an assembled sensor station.

FIGS. 3.1-3.3 depict various schematic assembly views of a sensor station.

FIGS. 4.1-4.5 depict various schematic views of a cable clamp being assembled on the seismic cable.

FIGS. 5.1-5.3 depict schematic views of a portion of the sensor station with the seismic cable connected thereto.

FIG. 6 is a flow chart depicting a method of manufacturing a seismic system.

FIG. 7 is a flow chart depicting a method of sensing seismic parameters.

### DETAILED DESCRIPTION

The description that follows includes exemplary apparatuses, methods, techniques, and instruction sequences that embody techniques of the inventive subject matter. However, it is understood that the described embodiments may be practiced without these specific details.

The techniques herein relate to sensor stations for use in seismic sensing systems. The sensor stations are connectable to seismic cable positioned about a surface location for measuring seismic parameters. The sensor stations may include a lightweight sensor housing having a sensor unit and portions of the seismic cable therein. The sensor housing includes cable clamps and a fiber racetrack for routing fibers of the seismic cable therethrough. Portions of the fibers may be spliced to the sensor unit. The sensor stations may also be provided with radio frequency identification (RFID) tags detectable by the seismic sensing system. The system seeks to provide high channel counts, long continuous cable lengths, access to sensor components for repair/replacement, and rapid deployment and retrieval, among other features.

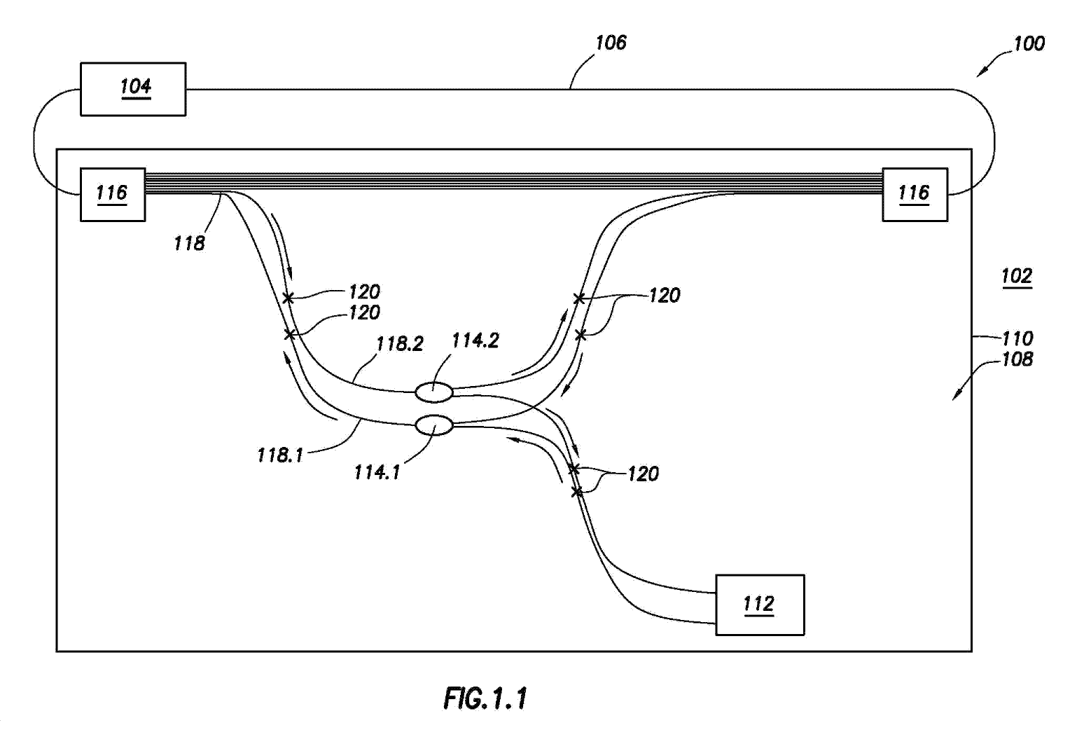

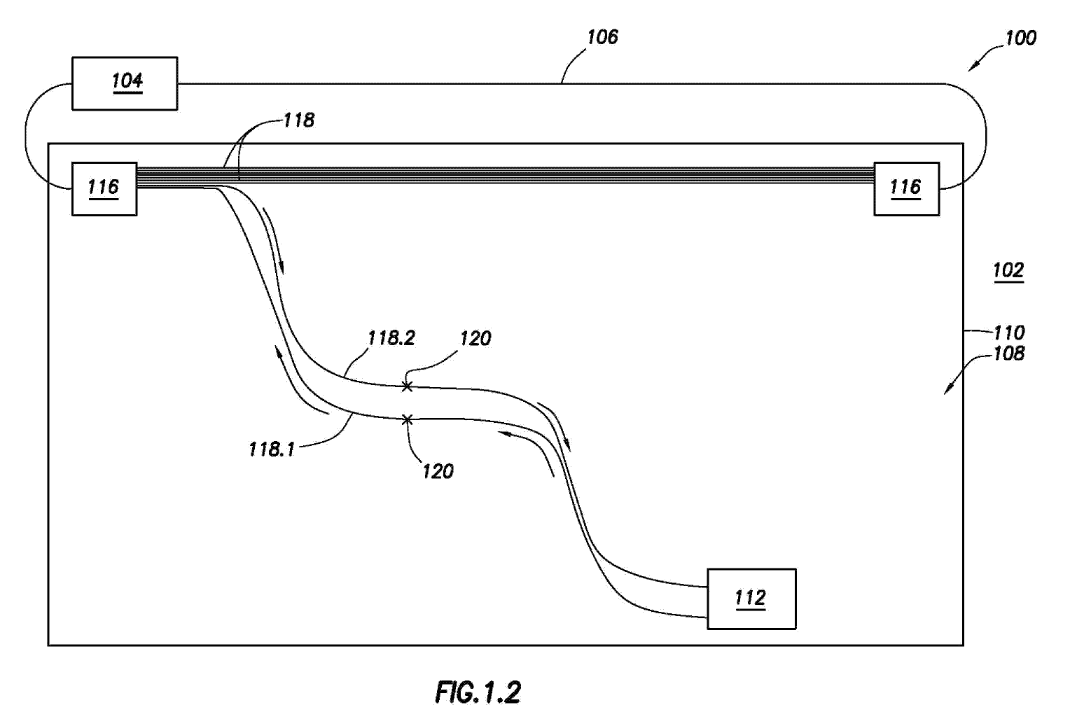

FIGS. 1.1-1.2 schematically depict a fiber optic system 100 positioned about a seismic field 102 for measuring seismic parameters of a subsurface formation therebelow. The seismic system includes a seismic station 104, seismic cable 106 and sensor station 108. The seismic station 104 may be, for example, a conventional seismic truck or base station with facilities for communication, processing data and performing seismic operations. The seismic cable 106 may be, for example, conventional seismic cable (e.g., fiber optic cable) that passes light between a light source in the seismic station 104 and the sensor station(s) 108. One or more sensor stations 108 and seismic cables 106 may be provided in various arrangements for communication with the seismic station 104. The fiber optic system 100 provides a continuous system for communication between the base station 104 and the sensor stations 108.

The sensor station 108 has a sensor housing 110, a sensor unit 112, telemetry splitters 114.1, 114.2, and clamps 116. The clamps 116 may be removably coupled to the seismic cable 106 at each end of the sensor station 108. The seismic cable 106 may have fibers 118 distributed through the sensor housing 110. The fibers 118 may be distributed through the sensor housing 110 for connection directly to the sensor unit 112 as shown in FIG. 1.2. Splices 120 may be provided along the fibers 118 to achieve the desired configuration. One or more incoming fibers 118.2 and one or more outgoing fibers 118.1 may be used. An incoming optical fiber 118.2 passes light from the seismic cable 106 to the sensor unit 112 to provide an input signal thereto as indicated by the arrows. An outgoing optical fiber 118.1 passes light from the sensor unit 112 to the seismic cable 106 to provide a return signal as indicated by the arrows.

Optionally, as depicted in FIG. 1.1, telemetry splitters 114.1, 114.2 may be positioned along the optical fiber 118 to provide means for attachment by the sensor unit 112. The telemetry splitters 114.1, 114.2 are spliced along optical fibers 118.1 and 118.2. An incoming optical fiber 118.2 passes light from the seismic cable 106 to the telemetry splitter 114.2 to provide an input signal as indicated by the arrows. An outgoing optical fiber 118.1 passes light from the telemetry splitter 114.1 to the seismic cable 106 to provide a return signal as indicated by the arrows.

While FIGS. 1.1 and 1.2 depict specific configurations of optical fibers distributed through a sensor station 108, any configuration of fibers 118 that enables light from the seismic cable 106 to pass to and from the sensor station 108 for communicating seismic data may be used. The sensor unit 112 may be, for example, a conventional optical accelerometer capable of detecting and communicating seismic data via an optical fiber, such as described in U.S. Pat. No. 7,222,534.

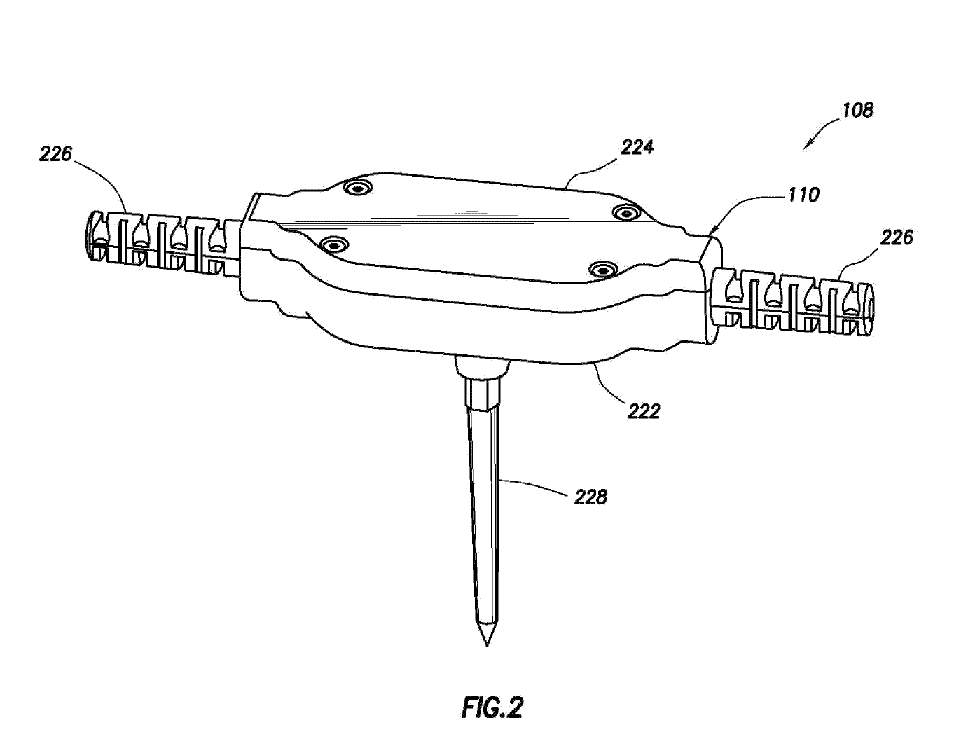

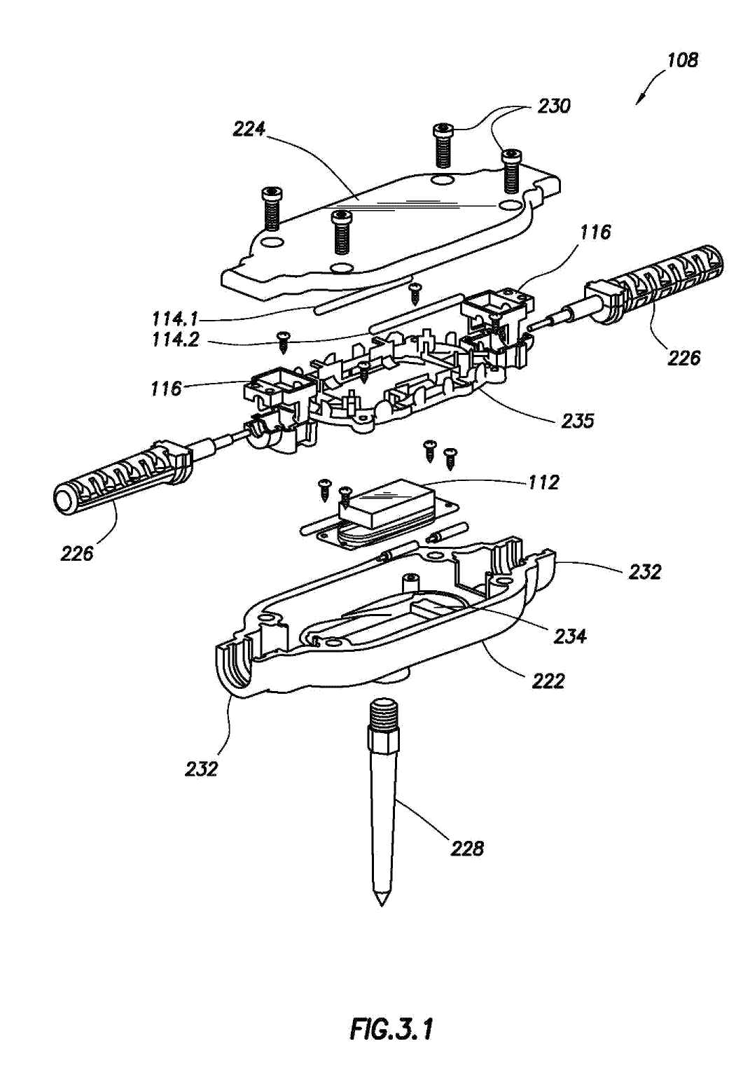

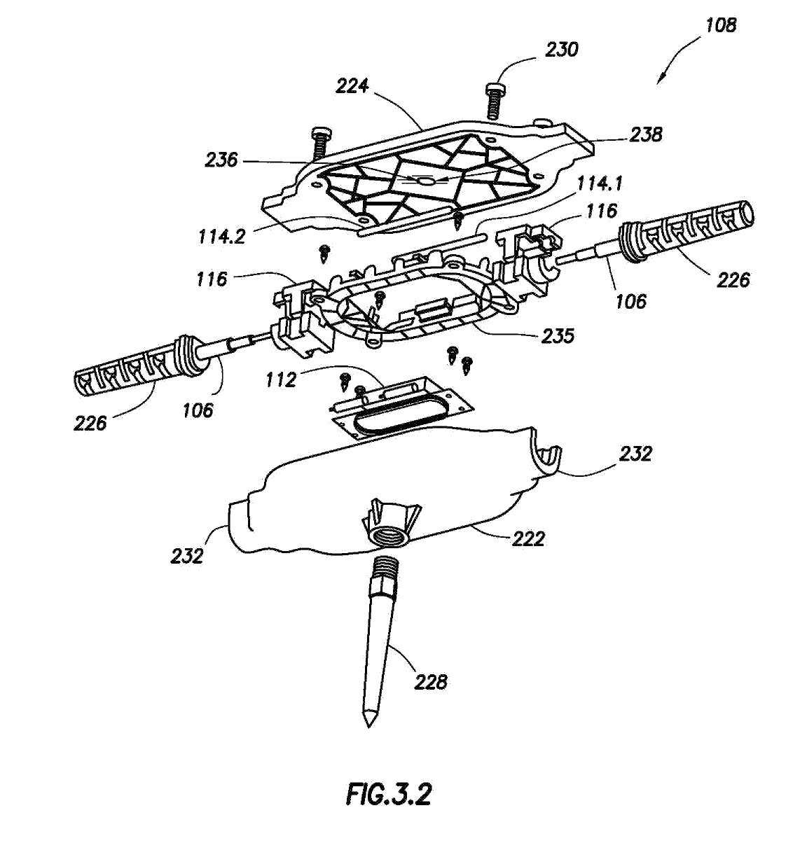

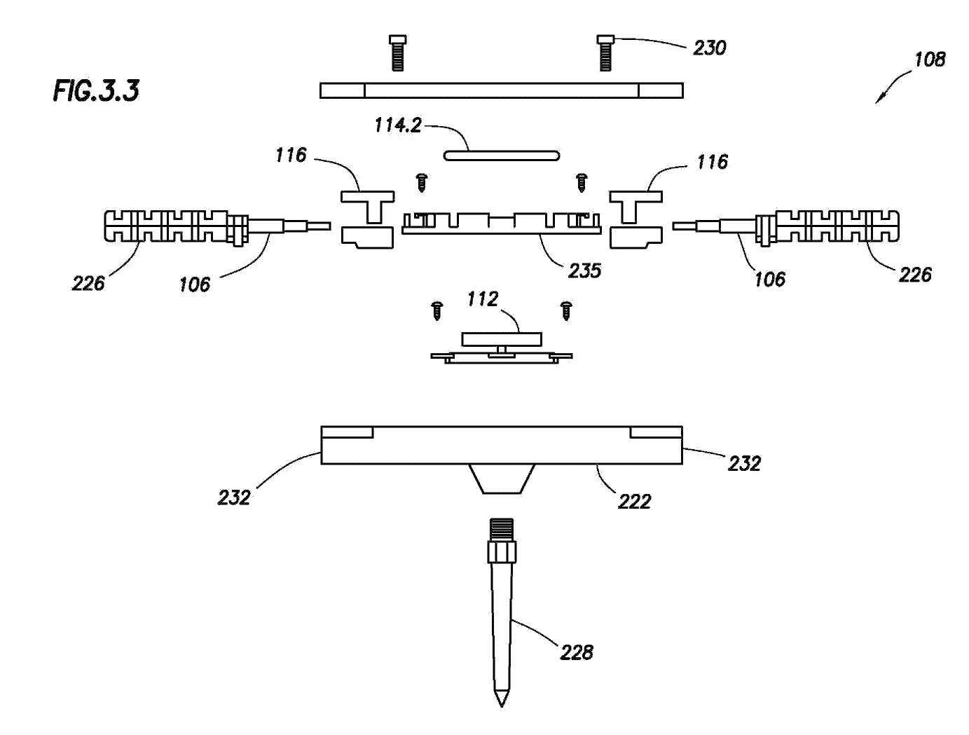

FIG. 2 is a schematic view of an assembled sensor station 108. FIGS. 3.1-3.3 depict exploded views of the sensor station 108 with a portions of the cable 106 depicted therein. As shown in FIG. 2, the sensor station 108 has a removable sensor housing 110 that includes a base 222 and a lid 224. The sensor station 108 is also provided with cable supports 226 and a sensor spike 228. The sensor station 108 is configured for connection to the seismic cable 106 and for placement about the seismic field 102 with the sensor spike 228 insertable into the ground. The spike 228 may be used, for example, to maintain an orientation (e.g., vertical) of the sensor station 108.

The sensor housing 110 may be configured to provide high channel count, light weight capabilities, and to provide a non-electronic cable spread. A lightweight, sturdy plastic may be used as the sensor housing 110. The sensor housing 110 may provide for receipt of optical fibers for internal access to components and for linking with the seismic cable 106. One or more sensor housings 110 may be positioned along various lengths of one or more independent or interconnected seismic cables 106.

The base 222 and lid 224 are positionable about the seismic cable 106 and secured in place using fasteners 230. The base 222 has receptacles 232 for receiving the cable 106 and the cable supports 226 on each end thereof. The cable supports 226 may be, for example, flexible tubes for supporting the cable in position to prevent damage or disengagement thereof. The base 222 also has a cavity 234 for receiving the fibers 118, the sensor unit 112, the telemetry splitters 114.1, 114.2 (if present), and other components of the sensor station 108. For example, the base 222 may receive a fiber racetrack 235 for positioning the fibers 118 therein. The lid 224 may be positionable on the base 222 to removably enclose the contents thereof. The lid 224 may be provided with a pocket 236 for receiving an RFID tag 238 and/or other components. Other fasteners 230 may be provided for securing the lid 224 to the base 222 and/or various components in the sensor station 108.

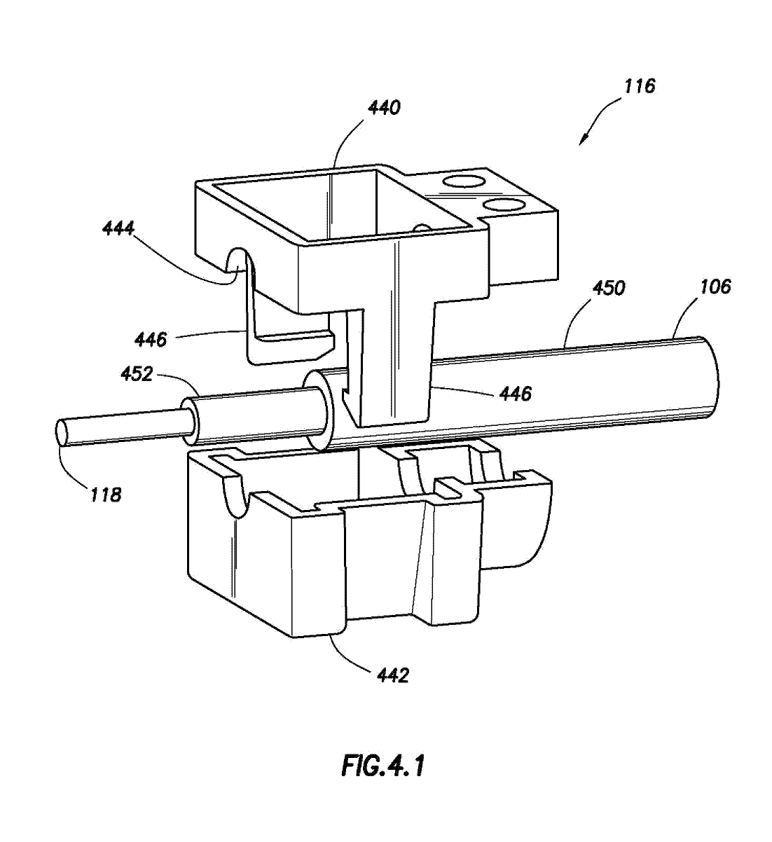

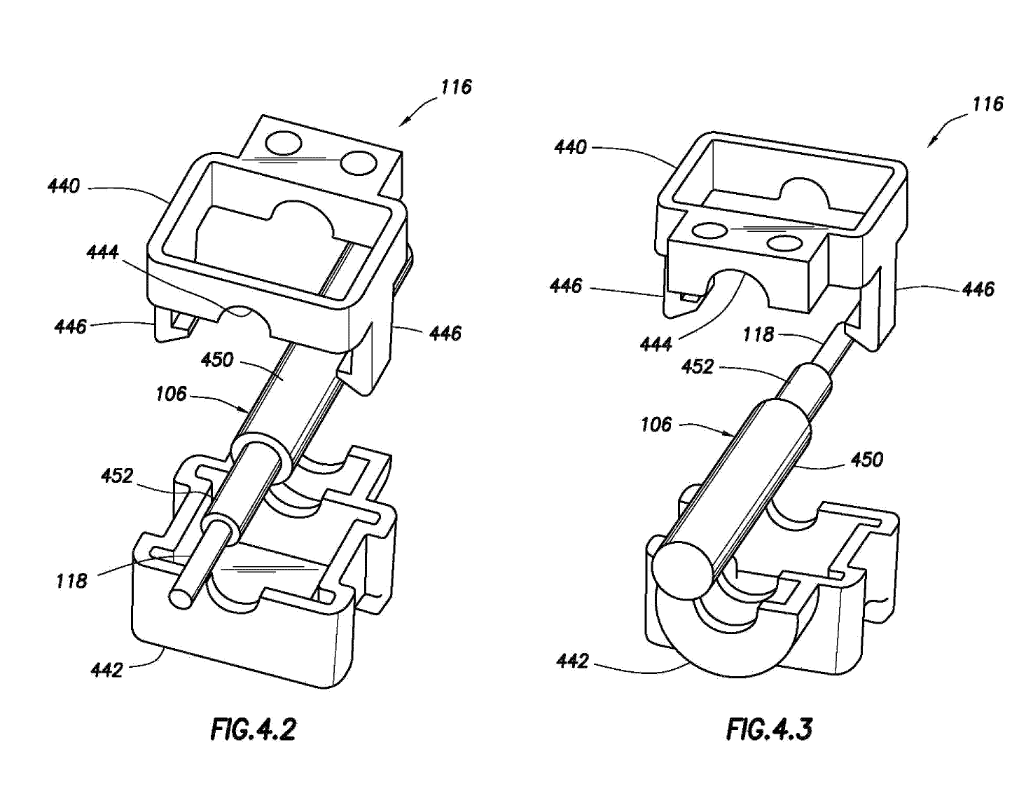

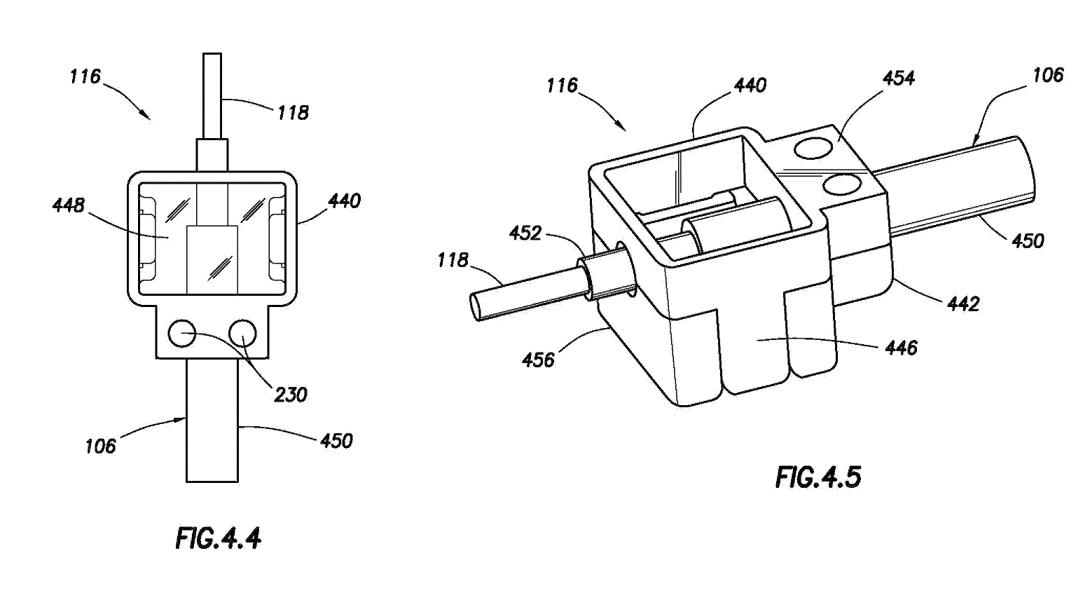

FIGS. 4.1-4.5 depict various views of the cable clamp 116 with the seismic cable 106 therein. The cable clamp 116 includes a top 440 and a bottom 442 defining a channel 444 for receiving the seismic cable 106. The top 440 may have locking arms 446 receivable in the bottom 442 for interlocking connection therebetween. Epoxy 448, fasteners 230 and/or other securing means may be provided for securing the seismic cable 106 in place within the locked cable clamp 116. A jacket 450 and strength member 452 (e.g., KEVLAR™) of the seismic cable 106 may be stripped back to reveal the fibers 118. The jacketed portion of the seismic cable 106 may extend through a cable end 454 of the cable clamp 116 and a stripped portion of the seismic cable 106 revealing the fibers 118 may extend through a fiber end 456 of the cable clamp 116.

The cable clamp 116 is configured for receipt into the sensor housing 110 as shown in FIGS. 3.1-3.3. The cable supports 226 may be positioned on either side of the cable clamp 116 for passing the seismic cable 106 thereto and providing additional support thereto. The cable clamp 116, cable support 226 and sensor housing 110 may support the seismic cable 106 to prevent damage thereto during use, transport and operation.

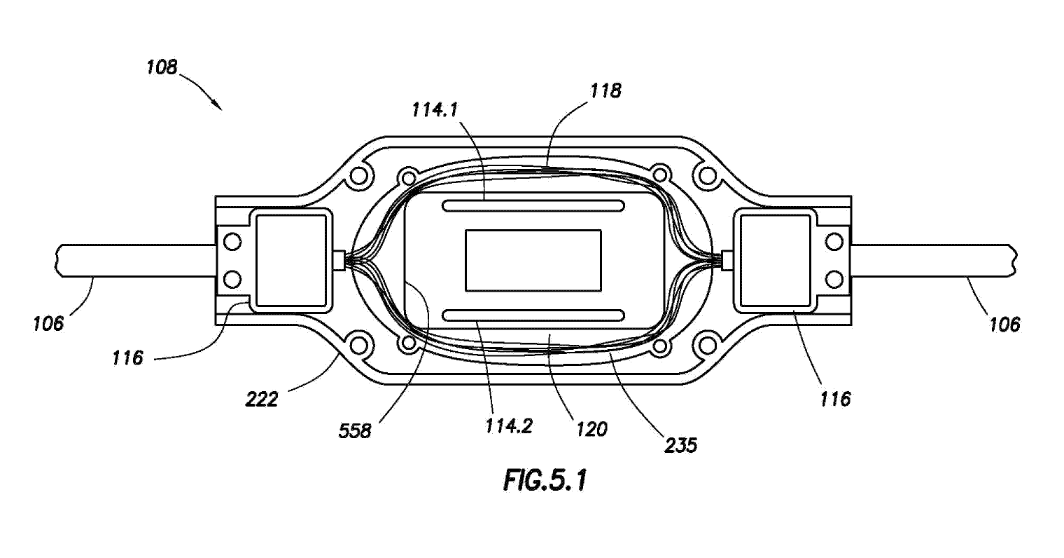

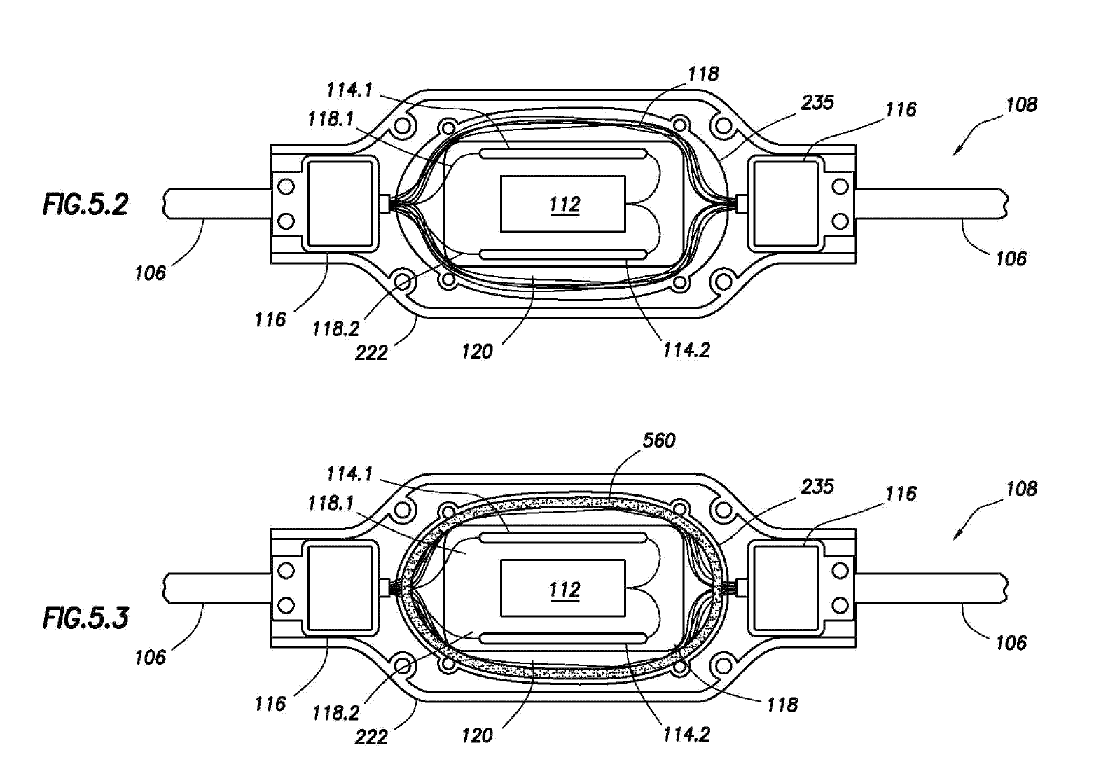

FIGS. 5.1-5.3 depict partially assembled views of the sensor station 108 connected to the cable 106. In these figures, the lid 224 is removed from the base 222 to reveal the interior of the sensor station 108. As shown in these figures, the lid 224 may be removed for access to components in the sensor housing 110, for example for repair/replacement As also shown in these figures, the sensor station 108 provides routing for an seismic cable to pass through the sensor station, and terminations for routing fibers 118 through the sensor housing 110 and to various components.

FIG. 5.1 shows the fiber racetrack 235 in position within the base 222 and having an opening 558 therethrough for receiving the sensor unit 112. The fiber racetrack 235 may be, for example, a plate of plastic or other material for supporting the fibers 118. The fiber racetrack 235 also provides a platform for positioning and supporting the fibers 118 passing through the sensor housing 110. The fiber racetrack 235 may be shaped to support the fibers 118 and fit within the base 222 of the housing 110. The shape, such as racetrack, oval or other shape, may be provided to divert the fibers through the housing 110, while allowing space to fit and access to components in the housing 110, such as the sensor unit 112 and the telemetry splitters 114.1, 114.2.

The seismic cable 106 is connected by the cable clamps 116 on either side of the fiber racetrack 235. The cable clamp 116 on one end of the sensor housing 110 positions the seismic cable 106 and the fibers 118 in the sensor housing 110 for distribution along the fiber racetrack 235. Most of the fibers 118 are merged into the seismic cable at cable clamp 116 on the other end of the sensor housing 110. A portion of the fibers 118 (in this case two fibers) within the sensor housing 110 are spliced to components for operation therewith as shown in FIGS. 5.2 and 5.3.

FIGS. 5.2 and 5.3 show the base 222 of the sensor station 108 with the sensor unit 112, telemetry splitters 114.1, 114.2, and fibers 118 therein. With the cable jacket 450 removed (see, e.g., FIGS. 4.1-4.5), the fibers 118 are disposed through the cable clamps 116 and passed into the sensor housing 110. Most of the fibers 118 are distributed about the fiber racetrack 235 around the sensor unit 112 and telemetry splitters 114.1, 114.2. In this configuration, the seismic cable 106 remains continuous through the sensor housing 110, and is coiled onto the fiber racetrack 235.

Of the bundle of multiple fibers 118 of the seismic cable 106, certain fibers in the bundle may be selected and spliced for use with the telemetry splitters 114.1, 114.2. Using, for example, the configuration of FIG. 1.1, fibers 118.1 and 118.2 may be spliced to each of the telemetry splitters 114.1, 114.2. The telemetry splitters 114.1, 114.2 may be packaged onto the fiber racetrack 235 or other support in the sensor housing 110. Each of the telemetry splitters 114.1, 114.2 may be spliced to the sensor unit 112. These splices provide a communication link between the sensor unit 112 and the seismic cable 106. Some of the fibers 118 may pass through the sensor housing 110 without splicing to any components.

A protective foam 560 may optionally be placed over the fibers 118 to further protect and secure the fibers 118 within the sensor housing 110. The lid 224 may be secured on the base 222 and the sensor station 108 deployed for use. The RFID tag 238 and other components may also be provided in the sensor housing 110.

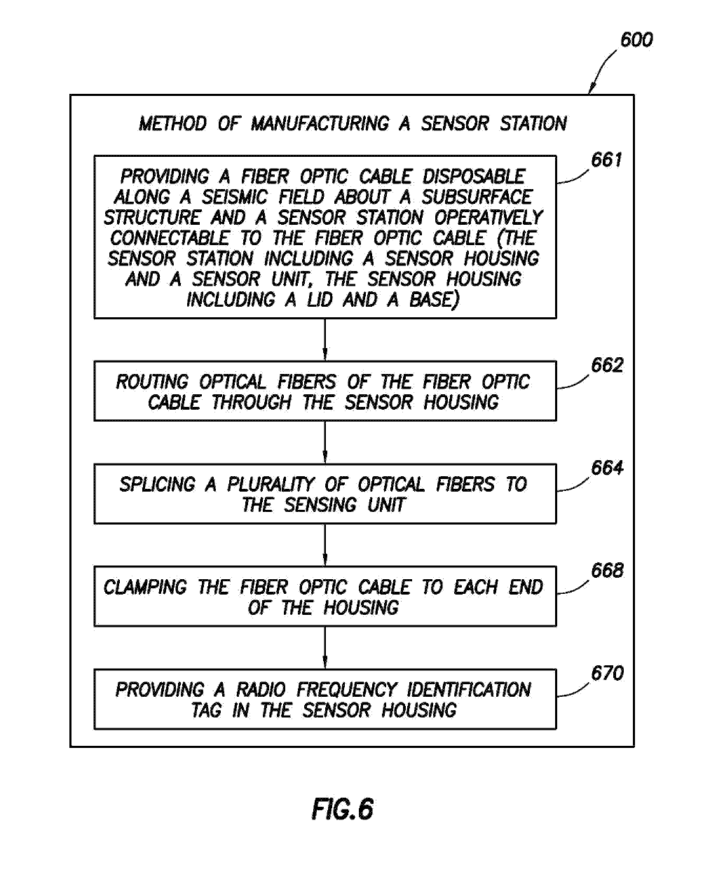

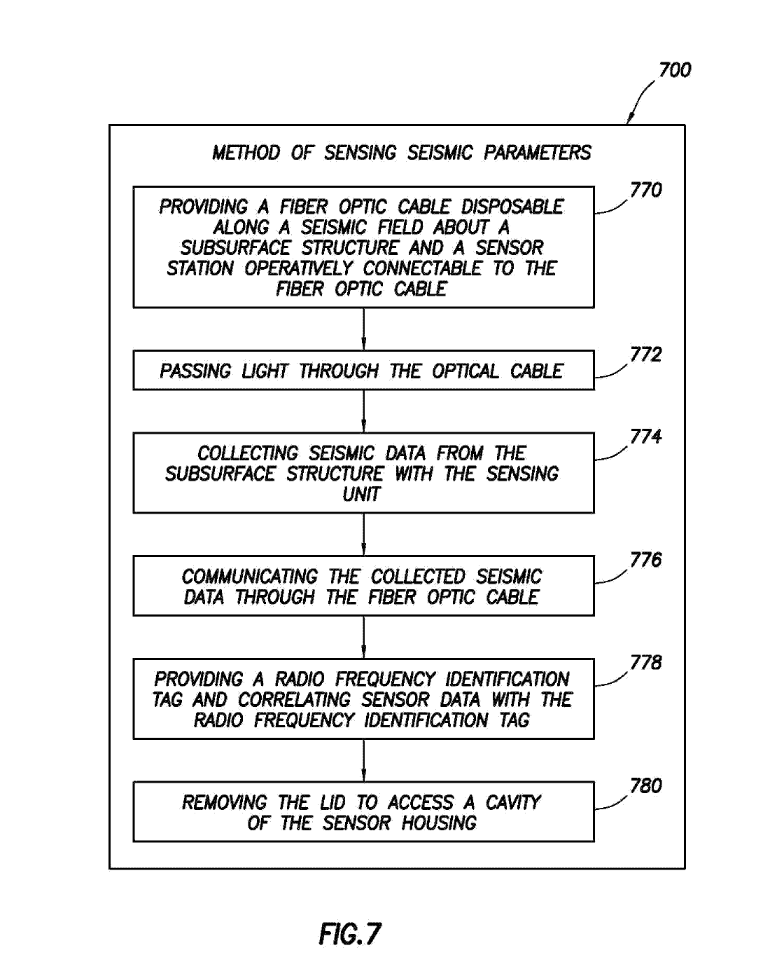

FIGS. 6 and 7 are flow charts depicting methods usable with the system 100 and/or sensor station 108 described herein. FIG. 6 depicts a method 600 for manufacturing a sensor system. The method involves providing 661 a fiber optic cable disposable along a seismic field about the subsurface structure, and a sensor station operatively connectable to the fiber optic cable. The sensor station may include a sensor housing and a sensor unit, the sensor housing comprising a lid and a base. The method 600 further involves routing 662 optical fibers of the fiber optic cable through the sensor housing, and splicing 664 a portion of the optical fibers to the sensor unit. The method may also involve clamping 668 the fiber optic cable at each end of the sensor housing, and providing 670 an RFID tag in the sensor housing.

FIG. 7 depicts a method 700 for sensing seismic parameters of a subsurface structure. The method 700 involves providing 770 a fiber optic cable disposable along a seismic field about the subsurface structure and a sensor station operatively connectable to the fiber optic cable. The sensor station includes a sensor housing and a sensor unit, the sensor comprising a lid and a base, with the optical fibers of the fiber optic cable routed through the sensor housing with a portion of the optical fibers spliced to the sensor unit. The method further involves passing 772 light through the seismic cable, collecting 774 seismic data from the subsurface structure with the sensor unit, and communicating 776 the collected seismic data through the fiber optic cable. The method may also involve providing 778 an RFID tag and providing sensor data with the RFID, and removing 780 the lid to access the cavity of the sensor housing.

The steps of the methods may be performed in any order and repeated as desired.

While the present disclosure describes specific techniques, numerous modifications and variations will become apparent to those skilled in the art after studying the disclosure, including use of equivalent functional and/or structural substitutes for elements described herein. For example, aspects of the disclosure can also be implemented in one or more sensor stations and/or one or more seismic cables.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A sensor station for sensing seismic parameters of a subsurface structure, the sensor station operatively connectable to a fiber optic cable disposable about a seismic field about the subsurface structure, the fiber optic cable comprising a plurality of optical fibers, the sensor station comprising:
a sensor housing comprising a base with a removable lid and receptacles for receiving the fiber optic cable therethrough, the base having a cavity therein accessible upon removal of the removable lid; and
a sensor unit positionable in the cavity of the sensor housing, the sensor unit operatively connectable to a portion of the plurality of optical fibers of the fiber optic cable for communicating seismic data sensed by the sensor unit.

2. The sensor station of claim 1, wherein the sensor housing comprises a racetrack, the plurality of optical fibers distributable about the racetrack.

3. The sensor station of claim 1, further comprising telemetry splitters positionable in the sensor housing and operatively connectable to portion of the plurality of optical fibers, the telemetry splitters linking fibers of the fiber optic cable to the sensor unit.

4. The sensor station of claim 1, further comprising cable clamps at each end of the sensor housing, the cable clamps supporting the fiber optic cable about the sensor housing.

5. The sensor station of claim 4, wherein the cable clamps each comprise a top and a bottom, the top having locking arms insertable into the bottom for interlocking connection therebetween and about the fiber optic cable.

6. The sensor station of claim 1, further comprising cable supports at each end of the housing.

7. The sensor station of claim 1, further comprising a spike operatively connectable to the sensor housing.

8. The sensor station of claim 1, further comprising a radio frequency identification tag positionable in the sensor housing.

9. The sensor station of claim 7, wherein the removable lid has a pocket for receiving the radio frequency identification tag.

10. The sensor station of claim 7, wherein the radio frequency identification tag is readable through the sensor housing.

11. The sensor station of claim 1, further comprising foam protectant positionable in the sensor housing about the plurality of optical fibers.

12. A system for sensing seismic parameters of a subsurface structure, the system comprising:
a fiber optic cable disposable along a seismic field about the subsurface structure, the fiber optic cable comprising a plurality of optical fibers; and
a sensor station, comprising:
a sensor housing comprising a base with a removable lid and receptacles for receiving the fiber optic cable therethrough, the base having a cavity therein accessible upon removal of the removable lid; and
a sensor unit positionable in the cavity of the sensor housing, the sensor unit operatively connectable to a portion of the plurality of optical fibers of the fiber optic cable for communicating seismic data sensed by the sensor unit.

13. The system of claim 12, further comprising a base station, the base station operatively connectable to the fiber optic cable.

14. The system of claim 12, wherein the fiber optic cable comprises a jacket.

15. A method for manufacturing a sensor system for sensing seismic parameters of a subsurface structure, the method comprising:
providing a fiber optic cable and sensor stations, the fiber optic cable disposable along a seismic field about the subsurface structure and comprising a plurality of optical fibers, the sensor stations, comprising:
a sensor housing comprising a base with a removable lid and receptacles for receiving the fiber optic cable therethrough, the base having a cavity therein accessible upon removal of the removable lid; and
a sensor unit positionable in the cavity of the sensor housing, the sensor unit operatively connectable to a portion of the plurality of optical fibers of the fiber optic cable for communicating seismic data sensed by the sensor unit;
routing the plurality of optical fibers through the sensor housing; and
splicing the portion of the plurality of fibers to the sensor unit.

16. The method of claim 15, further comprising clamping the fiber optic cable to each end of the sensor housing.

17. The method of claim 15, further comprising providing a radio frequency identification tag in the sensor housing.

18. The method of claim 15, wherein the splicing comprises operatively connecting telemetry splitters between the plurality of optical fibers and the sensing unit.

19. A method for sensing seismic parameters of a subsurface structure, the method comprising:
disposing a fiber optic cable and sensor stations along a seismic field about the subsurface structure, the fiber optic cable comprising a plurality of optical fibers, the sensor stations, comprising:
a sensor housing comprising a base with a removable lid and receptacles for receiving the fiber optic cable therethrough, the base having a cavity therein accessible upon removal of the removable lid; and
a sensor unit positionable in the cavity of the sensor housing, the sensor unit operatively connectable to a portion of the plurality of optical fibers of the fiber optic cable for communicating seismic data sensed by the sensor unit;
passing light through the fiber optic cable;
collecting the seismic data from the subsurface structure with the sensor unit; and
communicating the collected seismic data through the fiber optic cable.

20. The method of claim 19, further comprising removing the removable lid and accessing the cavity of the sensor housing.

21. The method of claim 19, further comprising providing a radio frequency identification tag and collecting sensor data from the radio frequency identification tag.

22. The method of claim 19, further comprising routing the plurality of optical fibers through the sensor housing; and

23. The method of claim 19, further comprising splicing the portion of the plurality of fibers to the sensor unit.
